(19) United States
(12) Patent Application Publication
(10) Pub. No.: US 2026/0203870 A1
(43) Pub. Date: Jul. 16, 2026

(54) IMAGE PROCESSING SYSTEM, IMAGE PROCESSING METHOD, AND PROGRAM

(71) Applicant: Sony Interactive Entertainment Inc., Tokyo (JP)

(72) Inventors: Dai Matsunaga, Kanagawa (JP); Takehiro Tominaga, Tokyo (JP); Florian Strauss, Victoria (DE)

(73) Assignee: Sony Interactive Entertainment Inc., Tokyo (JP)

(21) Appl. No.: 19/431,591

(22) Filed: Dec. 23, 2025

Related U.S. Application Data
(63) Continuation of application No. PCT/JP2024/022574, filed on Jun. 21, 2024.

(30) Foreign Application Priority Data
Jun. 30, 2023 (JP) 2023-108726

(51) Int. Cl. G06T 5/60; A63F 13/52; G06T 5/94; G06T 15/20

(52) U.S. Cl. CPC G06T 5/60; A63F 13/52; G06T 5/94; G06T 15/20; G06T 2207/20081; G06T 2207/20084

(57) ABSTRACT

Techniques include acquiring one or more input frames in which a first pixel value and a first brightness value are in a linear relationship. The techniques further include generating a converted input frame in which a second pixel value and a second brightness value are visually in a non-linear relationship by performing a non-linear conversion on the input frames. The techniques further include inputting the converted input frame to a machine learning model to cause an estimation frame to be acquired.

### CROSS-REFERENCES TO RELATED APPLICATIONS

This application is a Continuation application under 35 U.S.C. § 111 of International Application No. PCT/JP2024/022574, filed Jun. 21, 2024 and JP Application 2023-108726, filed Jun. 30, 2023, the entire contents of which are incorporated herein by reference for all purposes.

### BACKGROUND OF THE INVENTION

### Technical Field

The present disclosure relates to an image processing system, image processing method, and program.

### Background Art

A technique of estimating a high-resolution single image based on a low-resolution single image (super-resolution), using a conventional machine learning model, has been conventionally known (see Non Patent Literature 1 below).

CITATION LIST

### Non Patent Literature

Non Patent Literature 1: Chao Dong, Chen Change Loy, Kaiming He, Xiaoou Tang. Learning a Deep Convolutional Network for Image Super-Resolution, in Proceedings of European Conference on Computer Vision (ECCV), 2014.

### BRIEF SUMMARY OF THE INVENTION

### Technical Problem

In the aforementioned technique, when one or more of input frames, in which a pixel value and a brightness value are in a linear relationship, are inputted to a machine learning model, high-image quality enhancement also takes place equally in any brightness area. Here, in the visual sense properties of a human, the sensitivity of discriminating a difference in brightness differs in every brightness area. Specifically, in the visual sense properties of a human, the sensitivity is high in a difference in brightness in a low-brightness area, and the sensitivity is low in the difference in brightness in a high-brightness area. Therefore, even if the high-image quality enhancement of the high-brightness area takes place, it is difficult to recognise that the image quality is improved. On the other hand, it can be said that the higher image quality enhancement in the low-brightness area is preferable.

The object of the present disclosure is to provide an image processing system, an image processing method, and a program which aims at improving the image quality in accordance with the visual sense properties of a human.

### Solution to Problem

The image processing system according to the present disclosure includes at least one processor, where the at least one processor acquires the one or more of input frames in which a pixel value and a brightness value are in a linear relationship, generates a converted input frame in which the pixel value and the brightness value are in a non-linear relationship in accordance with the visual sense properties of a human by performing non-linear conversion in the input frame, and inputs the converted input frame to a machine learning model to acquire an estimation frame.

### BRIEF DESCRIPTION OF THE DRAWINGS

FIG. 1 is a drawing illustrating an example of a hardware configuration of an image processing system.

FIG. 2 is a drawing illustrating the overview of an image processing system.

FIG. 3 is a drawing schematically illustrating the process of an image processing system.

FIG. 4 is a function block diagram illustrating an example of functions actualised by an image processing system.

FIG. 5 is a drawing explaining the processing of a rendering unit.

FIG. 6 is a drawing explaining the processing in an input frame acquisition unit.

FIG. 7 is a drawing explaining the conversion processing of a frame in the present embodiment.

FIG. 8A is a graph illustrating an example of the relationship between a pixel value and a brightness value in one or more of input frames.

FIG. 8B is a graph illustrating an example of the relationship between a pixel value and a brightness value in one or more of input frames after the conversion.

FIG. 8C is a graph illustrating an example of a conversion function.

FIG. 9 is a flowchart illustrating an example of the flow of the processing executed by an image processing system.

FIG. 10 is a drawing explaining the conversion processing of a frame in the 1st modified example of the present embodiment.

FIG. 11 is a drawing explaining the conversion processing of a frame in the 2nd modified example of the present embodiment.

FIG. 12 is a drawing explaining the conversion processing of a frame in the 3rd modified example of the present embodiment.

### DETAILED DESCRIPTION OF THE INVENTION

An example of an embodiment of the image processing system according to the present disclosure will be explained below with reference to the drawings.

### 1. Hardware Configuration of an Image Processing System

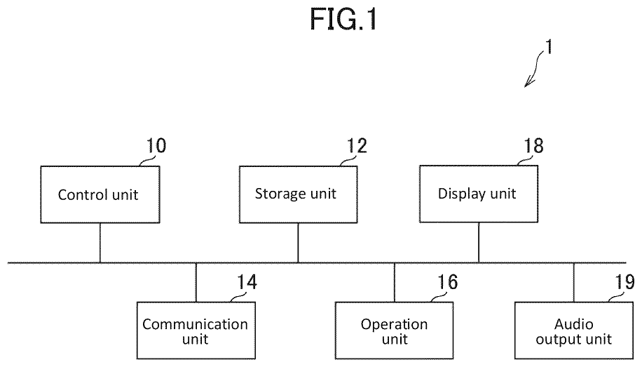

FIG. 1 is a drawing illustrating an example of a hardware configuration of an image processing system 1. The image processing system 1 is a computer of, for example, a game console (game machine), etc. As shown in FIG. 1, the image processing system 1 includes a control unit 10, a storage unit 12, a communication unit 14, an operation unit 16, a display unit 18 and an audio output unit 19.

The control unit 10 includes, e.g. a program control device such as a CPU operating in accordance with a program installed in the image processing system 1. Moreover, the control unit 10 also includes a GPU (Graphics Processing Unit) depicting an image in a frame buffer based on graphics commands and data supplied from the CPU.

The storage unit 12 includes, e.g. a main storage device such as a ROM or a RAM etc., and an auxiliary storage device such as an HDD or an SSD, etc. Programs and the like executed by the control unit 10 are stored in the storage unit 12. The storage unit 12 stores, in addition to a program for realizing all functions of the image processing system 1 mentioned below, a game program (game software) for example. Moreover, a frame buffer area, of which an image is depicted by GPU, is ensured in the storage unit 12.

The communication unit 14 is a communication interface such as an Ethernet (registered trademark) module or a wireless LAN module, etc.

The operation unit 16 is a user interface such as a keyboard or a mouse, a controller for a game console, etc., which receives an operation input of a user, and outputs a signal indicating the content thereof to the control unit 10.

The display unit 18 is a display device such as a liquid crystal display, an organic EL display, etc., which displays various kinds of images in accordance with an instruction of the control unit 10.

The audio output unit 19 is, for example, a speaker, which outputs audio indicated by audio data generated by the image processing system 1.

Besides the devices mentioned above, the image processing system 1 may also include an optical disk drive which reads an optical disk such as a DVD-ROM or a Blu-ray (registered trademark) disk, etc. or a USB (Universal Serial Bus) port, etc.

### 2. Overview of the Image Processing System

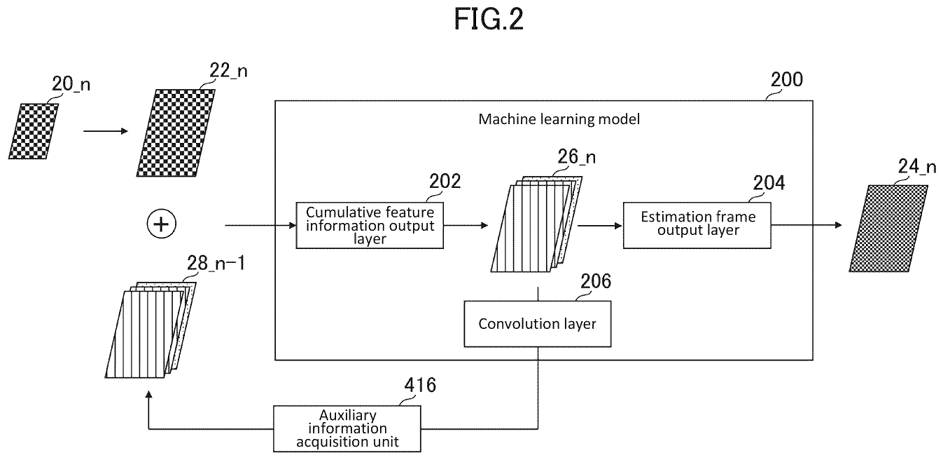

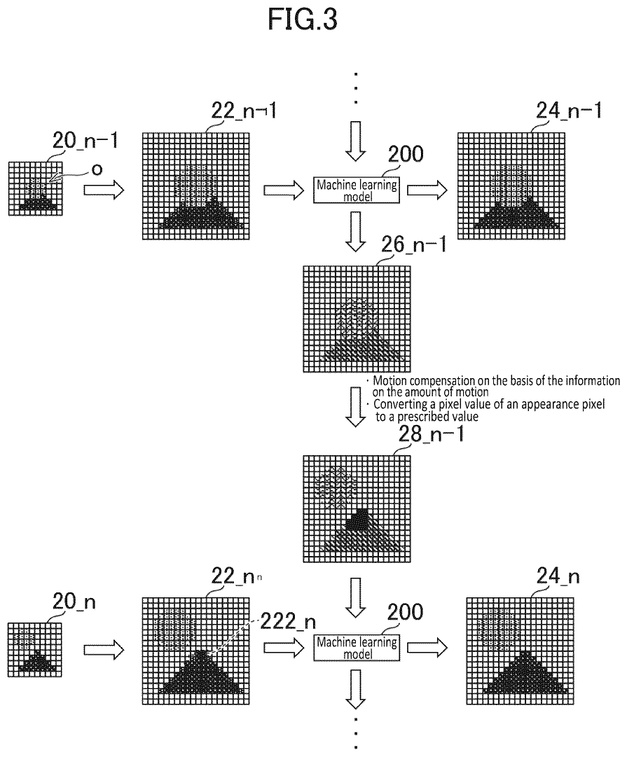

FIG. 2 is a drawing illustrating the overview of the image processing system 1. FIG. 3 is a drawing schematically illustrating the processing of the image processing system 1. The present embodiment exemplifies a case where the image processing system 1 is utilized to improve the image quality of a play moving image in a game. The play moving image is a moving image generated depending on a game program executed by the control unit 10 or an input by a user received by the operation unit 16, and is configured from a plurality of still images (frames) which are time series data. The process which takes place in the image processing system 1 is mainly as follows.

### (1) Generation of Processing Target Frames

The image processing system 1 generates an image depicted by a game object (processing target frame) by executing rendering of three-dimensional data indicating one or more of these game objects as seen from a prescribed viewpoint. This process target frame is an image having a prescribed pixel number (initial pixel number) and the prescribed image quality (initial image quality) (see FIG. 3). A process target frame is generated in every prescribed time. The pixel number of a processing target frame is, for example, 1920×1080(1080 p). Each generated process target frame is not displayed as-is on the display unit 18, but is once accommodated in the storage unit 12, and has a subsequent process applied thereto. In the following explanation, a process of an nth process target frame 20_n (2≤n≤N, n and N are natural numbers equal to or greater than 2) as a target will be mainly exemplified. Meanwhile, the same process is also executed on other process target frames (namely, n=2, 3, . . . , N).

### (2) Acquisition of Input Frames

The image processing system 1, based on an acquired process target frame 20_n, acquires a frame (input frame) 22_n having a pixel number greater than an initial pixel number (input pixel number). The input pixel number is, for example, 3840×2160 (4 K). Specifically, one or more of input frames 22_n are generated by enlargement and interpolation processes being on the process target frame 20_n (see FIG. 3).

Here, although the one or more of input frames 22_n have a pixel number greater than the pixel number of the process target frame 20_n, it should be noted that the image quality thereof has not necessarily been sufficiently improved. Namely, the image quality of a frame does not mean a mere large pixel number (high degree of image quality). The image quality of the frame may be evaluated based on, for example, each of or a comprehensive consideration of a high SN ratio, high reproducibility of a space frequency, high time stability (few artefacts or flickering when a plurality of frames is continuously displayed), etc. when compared with a frame serving as a standard.

### (3) Acquisition of Estimation Frames

The image processing system 1 inputs the one or more of input frames 22_n to a machine learning model 200, and acquires an estimation frame 24_n. The estimation frame 24_n is an image having the same pixel number as an input pixel number (estimated pixel number), and having the image quality equal to or higher than the initial image quality (estimated image quality) (see FIG. 3).

Here, in addition to the one or more of input frames 22_n, the (n−1)th auxiliary information 28_n−1 is inputted to the machine learning model 200 (see FIGS. 2 and 3). The auxiliary information 28_n−1 is information based on an (n−1)th cumulative feature information 26_n-1 indicating the features of the 1st to (n−1)th input frames 22. Details of the cumulative feature information 26 and the auxiliary information 28 are described below.

### (4) Acquisition of Cumulative Feature Information

The machine learning model 200 has the one or more of input frames 22_n and the auxiliary information 28_n−1 inputted thereto, and has a cumulative feature information output layer 202 which outputs the nth cumulative feature information 26_n indicating the features of the 1st to nth input frames 22 (see FIG. 2). The image processing system 1 acquires the nth cumulative feature information 26_n.

The acquired nth cumulative feature information 26_n is inputted to an estimation frame output layer 204, and the nth estimation frame 24_n is outputted from the estimation frame output layer 204 (see FIG. 2). The acquired nth cumulative feature information 26_n is also accommodated in the storage unit 12, and has the estimation of the estimation frame 24_n+1 which corresponds to the next processing target frame ((n+1)th processing target frame) 20_n+1 applied thereto.

### (5) Acquisition of Auxiliary Information

As mentioned above, the (n−1)th cumulative feature information 26_n−1 is information indicating the features of the 1st to (n−1)th input frames 22 (and the 1st to (n 1)th processing target frames 20 in the long run). If the cumulative feature information 26_n−1 indicating accumulation of the information of a past processing target frame 20 is utilized for the estimation of the nth estimation frame 24_n, information that can be used for the estimation increases, and hence a high-image quality estimation frame 24_n can be obtained.

However, in a case where there is motion, etc. in a game object displayed between the (n−1)th processing target frame 20_n−1 and the nth processing target frame 20_n, when the nth input frame 22_n and the cumulative feature information 26_n−1 are inputted as-is to the machine learning model 200, a phenomenon could occur in which a residual image of a game object which was displayed in the (n−1)th processing target frame 20_n−1 is displayed (the so-called ghost phenomenon).

Thus, the image processing system 1 acquires the (n−1)th auxiliary information 28_n−1 by applying various corrections mentioned below, based on information (motion vector, depth buffer, etc.) obtainable at the time of rendering to the cumulative feature information 26_n−1 (see FIGS. 2 and 3). As mentioned above, the acquired (n−1)th auxiliary information 28_n−1, together with the nth input frame 22_n, is inputted to the machine learning model 200 and has the estimation of the nth estimation frame 24_n applied thereto.

As explained above, the image processing system 1 according to the present embodiment uses, in addition to the one or more of input frames 22 corresponding to the present processing target frame 20, the auxiliary information 28 indicating the accumulation of the past information, and estimates the estimation frame 24. Thereby, the information that can be used for the estimation increases and hence the high-image quality estimation frame 24_n can be obtained.

### 3. Functions Realized by the Image Processing System

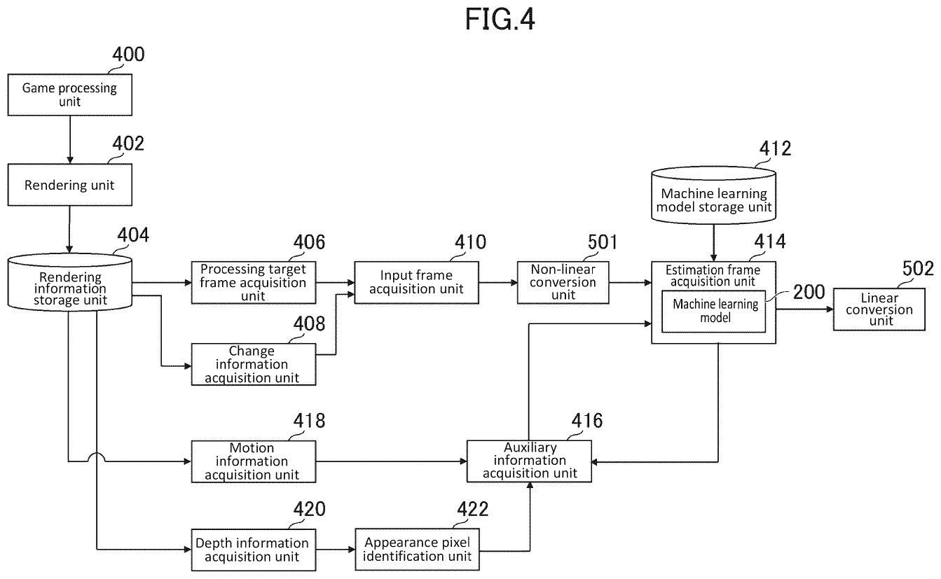

FIG. 4 is a function block diagram illustrating an example of functions realized by the image processing system 1. As shown in FIG. 4, a game processing unit 400, a rendering unit 402, a rendering information storage unit 404, a processing target frame acquisition unit 406, a change information acquisition unit 408, the one or more of input frames acquisition unit 410, a machine learning model storage unit 412, an estimation frame acquisition unit 414, an auxiliary information acquisition unit 416, a motion information acquisition unit 418, a depth information acquisition unit 420, an appearance pixel identification unit 422, a non-linear conversion unit 501, and a linear conversion unit 502 are realized in the image processing system 1.

The game processing unit 400, the rendering unit 402, the processing target frame acquisition unit 406, the change information acquisition unit 408, the input frame acquisition unit 410, the estimation frame acquisition unit 414, the auxiliary information acquisition unit 416, the motion information acquisition unit 418, the depth information acquisition unit 420, the appearance pixel identification unit 422, the non-linear conversion unit 501, and the linear conversion unit 502 are realized mainly by the control unit 10. The rendering information storage unit 404 and the machine learning model storage unit 412 are realized mainly by the storage unit 12. The game processing unit 400, the rendering unit 402 and the rendering information storage unit 404 are functions provided by a game software.

### Game Processing Unit

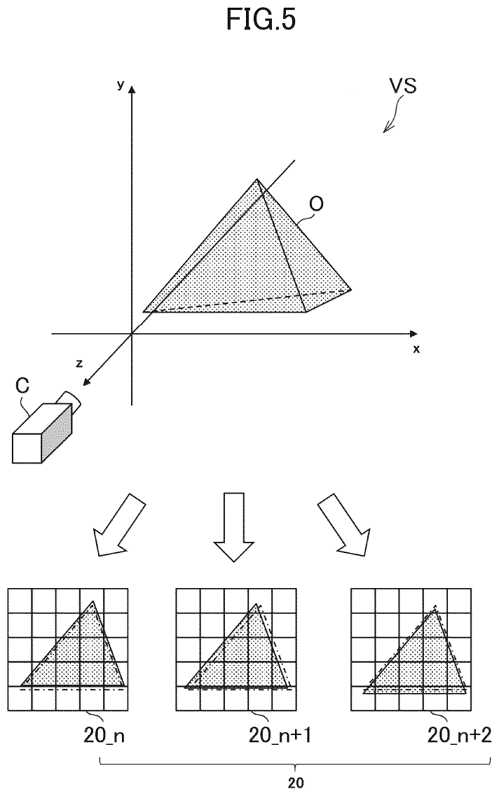

The game processing unit 400 executes various kinds of processes relating to a game. The game processing unit 400 executes, for example, the following processes: arranging a game object O in a virtual three-dimensional space VS, operating or moving the game object O, or changing a viewpoint C for viewing the virtual three-dimensional space VS, etc., depending on the game program executed by the control unit 10 or the input by a user received by the operation unit 16 (see FIG. 5). The game object O is configured by a primitive such as a polygon indicated by three-dimensional data. The three-dimensional data includes geometrical information indicating the position of a vertex, etc., phase information indicating how the vertexes are tied, and attribute information such as a colour, etc.

### Rendering Unit

FIG. 5 is a drawing explaining the processing in the rendering unit 402. The rendering unit 402 generates 1st to Nth processing target frames 20 (N is a natural number equal to or greater than 2) by executing the three-dimensional data rendering (depiction process) indicating one or more of the game objects O as seen from a prescribed viewpoint C. The rendering unit 402 executes the rendering based on the various processing results executed by the game processing unit 400. Specifically, the rendering unit 402 executes a vertex process (vertex shading) and a pixel process (pixel shading), based on the three-dimensional data indicating the game object O arranged in the virtual three-dimensional space VS. The vertex process includes a coordinate conversion process (perspective projection) from a view coordinate system to a screen coordinate system, and a numerical value relating to a change of the viewpoint C is added to a perspective projection matrix (camera matrix) which is used for the coordinate conversion process, as mentioned below. The rendering unit 402 may also execute the rendering based on light source information or depth information (depth buffer), texture information, and normal line information, etc.

Here, the rendering unit 402 generates each process target frame 20 by executing the rendering so that the viewpoint C changes for every processing target frame 20. Here, even if the game processing unit 400 already fixed the viewpoint C to a prescribed position, the rendering unit 402 changes the viewpoint C for every processing target frame 20. As a result, as shown in FIG. 5, the position of the displayed game object O is changed in each of the processing target frames 20_n, 20_n+1, 20_n+2. In other words, the rendering unit 402 applies jitter at the time of generating each process target frame 20. Specifically, the rendering unit 402 changes the viewpoint C for every processing target frame 20 by adding, to the perspective projection matrix, a numerical value corresponding to a size less than one pixel, which differs in every processing target frame 20. The rendering unit 402 changes the viewpoint C for every processing target frame 20 in accordance with a prescribed rule. The Halton sequence, for example, can be used as such a rule.

### Rendering Information Storage Unit

The rendering information storage unit 404 stores information required in the rendering process by the rendering unit 402, and information obtainable as a result of the rendering process. For example, the rendering information storage unit 404 stores the process target frame 20. Moreover, the rendering information storage unit 404 stores the change information, the motion information and the depth information. Details of the change information, the motion information and the depth information are described below. In addition, the rendering information storage unit 404 may store parameters used for coordinate conversion, light source information, texture information, and normal line information, etc.

### Process Target Frame Acquisition Unit

The process target frame acquisition unit 406 acquires each of 1st to Nth process target frames 20. Specifically, the process target frame acquisition unit 406 acquires each of the 1st to Nth process target frames 20 stored in the rendering information storage unit 404.

### Change Information Acquisition Unit

The change information acquisition unit 408 acquires the change information. The change information acquisition unit 408 acquires the change information stored in the rendering information storage unit 404. Specifically, the change information is information indicating the amount of change of the viewpoint C before and after the change. The information indicating the amount of change can also be a change vector indicating the direction and the distance of change. For example, since the information indicating the amount of change of the viewpoint C is included in the aforementioned Halton sequence, such information may be used as the change information.

### Input Frame Acquisition Unit

The input frame acquisition unit 410 acquires each of the 1st to Nth input frames 22 by generating the one or more of input frames 22 which corresponds to the process target frame 20 and which has the input pixel number equal to or greater than the initial pixel number, based on each process target frame 20. In the present embodiment, each input frame 22 has the input pixel number greater than the initial pixel number. Namely, in the present embodiment, each input frame 22 is an image obtained by enlarging the processing target frame 20 corresponding to the one or more of input frames 22.

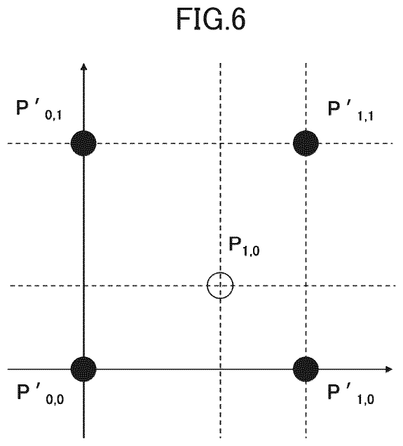

Specifically, the input frame acquisition unit 410 obtains the pixel value of the position corresponding to each pixel before the change by the interpolation in the process target 20, based on the change information and each pixel of each process target frame 20, and generates each input frame 22. FIG. 6 is a drawing explaining the process in the input frame acquisition unit 410. FIG. 6 exemplifies a case where the nth input frame 22_n is obtained. For example, as shown in FIG. 6, if the pixel center of the pixel in the one or more of input frames 22_n to be acquired is P1,0, the input frame acquisition unit 410 obtains the pixel value of P1,0 by bilinear interpolation, based on the coordinates and the pixel values of the pixel centers P′0,0, P′1,0, P′0,1, and P′1,1 of the four respective pixels closest to P1,0 in the processing target frame 20_n. Here, P′1,0 is at a position shifted from P1,0 by the amount of change indicated by the change information. A pixel value of a newly generated pixel is also similarly obtained by the enlargement process. In addition to the bilinear interpolation, various publicly known methods such as bicubic interpolation and Lanczos interpolation, etc. can be used as the method of interpolation.

When the rendering is executed so that the viewpoint C changes in every process target frame 20, the amount of time series information increases. If each of the thus obtained process target frames 20 (hereinafter referred to as “change processing target frame”) is utilized for the estimation, the higher image quality estimation frame 24 can be obtained.

On the other hand, if the change process target frame (or the enlarged image thereof) is inputted as-is to the machine learning model 200, the estimation accuracy may be reduced due to the influence of the change of the aforementioned viewpoint C.

Thus, as described above, the image processing system 1 is configured so that the pixel value of the position corresponding to each pixel before the change is obtained by the interpolation in the process target frame 20, based on the change information and each pixel of each process target frame 20, and each input frame 22 is generated and inputted to the machine learning model 200. Thereby, the influence of the change of the viewpoint C is corrected and hence lowering of the estimation precision can be suppressed.

### Machine Learning Model

The machine learning model 200 is a model which estimates the nth estimation frame 24_n based on the nth input frame 22_n. Specifically, the machine learning model 200 is a model which estimates the nth estimation frame 24_n based on the nth input frame 22_n and the (n−1)th auxiliary information 28_n−1. Specifically, the machine learning model 200 is a convolutional neural network (CNN). Publicly known models such as multilayer structure ResNet having a residual connection mechanism and the so-called encoder-decoder type U-Net, etc. can be used as the machine learning model 200. The model described in Non Patent Literature 1 may also be used as the machine learning model 200.

The machine learning model 200 is the model which has learnt by the plurality of training data which respectively includes the learning input frame having the input pixel number and the learning estimation frame having the estimated pixel number. Various publicly known methods such as backpropagation, etc. can be used for the learning by the machine learning model 200.

Specifically, the machine learning model 200 includes the cumulative feature information output layer 202, the estimation frame output layer 204 and a convolution layer 206 (see FIG. 2).

The cumulative feature information output layer 202 has the nth input frame 22_nand the (n−1)th auxiliary information 28_n−1 based on the (n−1)th cumulative feature information 26_n−1 indicating the features of the 1st to (n−1)th input frames 22 inputted thereto, and outputs the nth cumulative feature information 26_n indicating the features of the 1st to nth input frames 22_n. The cumulative feature information output layer 202 may be configured from, for example, one or more convolution layers. The cumulative feature information 26_n−1 is image information having the same pixel number as the input pixel number (bitmap format information). The cumulative feature information 26_n−1 may also be a feature map indicating the features of the 1st to (n−1)th input frames 22.

The cumulative feature information output layer 202 has the 1st input frame 22_1 and a given auxiliary information inputted thereto, and outputs the 1st cumulative feature information 26_1. When n=1, because the cumulative feature information 26 and the auxiliary information 28 do not exist prior thereto, given auxiliary information prepared beforehand, together with the 1st input frame 22_1, is inputted to the cumulative feature information output layer 202.

The estimation frame output layer 204 has the nth cumulative feature information 26_n inputted thereto and outputs the nth estimation frame 24_n. The estimation frame output layer 204 may be configured from, for example, one or more convolution layers like the cumulative feature information output layer 202. Alternatively, the estimation frame output layer 204 may also be configured from one or more transposed convolution layers (reverse convolution layers).

The convolution layer 206 is a layer which maintains the pixel number of the cumulative feature information 26, whilst reducing the channel number thereof. The cumulative feature information 26 outputted from the convolution layer 206 has the process with the auxiliary information acquisition unit 416 applied thereto. Since the dimensions of the cumulative feature information 26 are reduced according to the convolution layer 206, the calculation costs can be suppressed. The convolution layer 206 is, for example, a convolution layer with a kernel size of 1×1, but is not limited to this.

### Machine Learning Model Storage Unit

The machine learning model storage unit 412 stores the machine learning model 200. Specifically, the machine learning model storage unit 412 stores the parameters of the machine learning model 200 (the number of convolution layers, the number of notes used in each convolution layer, and the weight of each note, etc.).

### Estimation Frame Acquisition Unit

The estimation frame acquisition unit 414 inputs each input frame 22 to the machine learning model 200, and acquires each of the 1st to Nth estimation frames 24 having the estimated pixel number equal to or greater than the input pixel number which is greater than the initial pixel number. In the present embodiment, the estimation frame 24 has the same estimated pixel number as the input pixel number. More specifically, the estimation frame acquisition unit 414 inputs the nth input frame 22_n and the (n-1)th auxiliary information 28_n−1 to the machine learning model 200, and acquires the nth estimation frame 24_n.

### Motion Information Acquisition Unit

The motion information acquisition unit 418 acquires the (n−1)th motion information which indicates the amount and the direction of the motion from the (n−1)th process target frame 20_n−1 to the nth process target frame 20_n. Specifically, the (n 1)th motion information is image information which has the pixels with the same number as the input pixel number, and which indicates the amount and the direction of motion of each pixel between the (n−1)th processing target frame 20_n−1 and the nth processing target frame 20_n (bitmap format information). The motion information is also called motion vector. Specifically, the motion information acquisition unit 418 acquires the original motion information having the same pixel number as the initial pixel number, and acquires the motion information having the pixels with the same number as the input pixel number by executing the enlargement and the interpolation processes on the original motion information.

### Depth Information Acquisition Uni

The depth information acquisition unit 420 acquires the (n−1)th depth information indicating each pixel depth of the (n−1)th process target frame 20_n−1, and the nth depth information indicating each pixel depth of the nth process target frame 20_n. Specifically, the depth information is image information having the pixels with the same number as the input pixel number (bitmap format information). The depth information is also called depth buffer or Z buffer. Specifically, the depth information acquisition unit 422 acquires the original depth information having the pixel number as the initial pixel number, and acquires the depth information having the pixels with the same number as the input pixel number by executing the enlargement and the interpolation processes on the original depth information.

### Appearance Pixel Identification Unit

The appearance pixel identification unit 422 specifies, based on the (n−1)th depth information and the nth depth information, an nth appearance pixel 422_n being is a fully or partially displayed pixel of the game object O which is not displayed in the (n−1)th input frame 22_n−1 amongst the pixels of the nth input frames 22_n (see FIG. 3). Specifically, the appearance pixel identification unit 422 specifies the nth appearance pixel 422_n, based on the difference between the (n−1)th depth information and the nth depth information. The appearance pixel identification unit 422 may also specify the nth appearance pixel 422_n, based on the (n−1)th perspective projection matrix relating to the (n-1)th input frame 22_n−1 and the nth perspective projection matrix relating to the nth input frame 22_n. Moreover, the appearance pixel identification unit 422 may also specify the nth appearance pixel 422_n using the (n−1)th motion information. More specifically, the appearance pixel identification unit 422 specifies the nth appearance pixel 422_n, and generates an nth appearance pixel information, which is image information indicating the position of the nth appearance pixel 422_n.

### Auxiliary Information Acquisition Unit

The auxiliary information acquisition unit 416, based on the (n−1)th motion information, is configured so that motion compensation is applied to the (n−1)th cumulative feature information 26_n−1, and the auxiliary information acquisition unit 416 acquires the (n−1)th auxiliary information 28_n−1. The motion compensation is a process for moving a pixel at a position x of the (n−1)th cumulative feature information 26_n to a position x′, for example, in a case where the pixel at the position x in the (n 1)th input frame 22_n−1 moved to the position x′ in the nth input frame 22_n (see FIG. 5). Namely, the auxiliary information acquisition unit 416 acquires the (n−1)th auxiliary information 28_n−1, so that, based on the (n−1)th motion information, the respective pixel values of the one or more pixels of the (n−1)th cumulative feature information 26_n 1 are set to the pixels at the positions to which the pixels move in accordance with the amount and the direction of the motion of the pixels.

In a case where the game object O moved between the nth processing target frame 20_n and the (n−1)th processing target frame 20_n−1, at the time of acquiring the nth estimation frame 24_n, when the nth input frame 22_n and the (n−1)th cumulative feature information 26_n−1 are inputted as-is to the machine learning model 200, the ghost phenomenon could occur in the nth estimation frame 24_n to be outputted, in which the residual image of the game object O displayed in the nth input frame 22_n is displayed.

Thus, as described above, the image processing system 1 is configured so that, the (n−1)th auxiliary information 28_n−1 is acquired by the motion compensation applied to the (n−1)th cumulative feature information 26_n−1, based on the (n−1)th motion information, and, at the time of acquiring the nth estimation frame 24_n, the (n−1)th auxiliary information 28_n−1 is inputted to the machine learning model 200. Thereby, the aforementioned ghost phenomenon can be suppressed.

### Non-Linear Conversion Unit

The non-linear conversion unit 501 generates the frame in which the pixel value and the brightness value are in a non-linear relationship, by performing non-linear conversion on the one or more of input frames 22 in which the pixel value and the brightness value are in a linear relationship. Details of the non-linear conversion by the non-linear conversion unit 501 are described below.

### Linear Conversion Unit

The linear conversion unit 502 generates the frame in which the pixel value and the brightness value are in the linear relationship, by performing the non-linear conversion on the estimation frame 24 in which the pixel value and the brightness value are in the non-linear relationship. Details of the non-linear conversion by the linear conversion unit 502 are described below.

### 4. Conversion Processing of a Frame

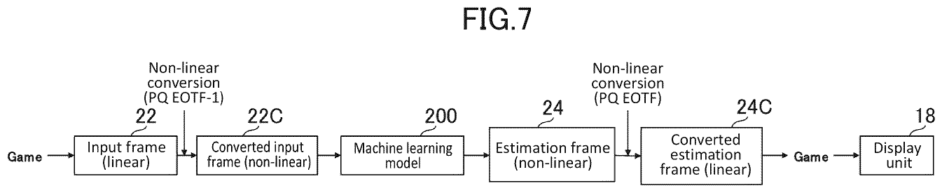

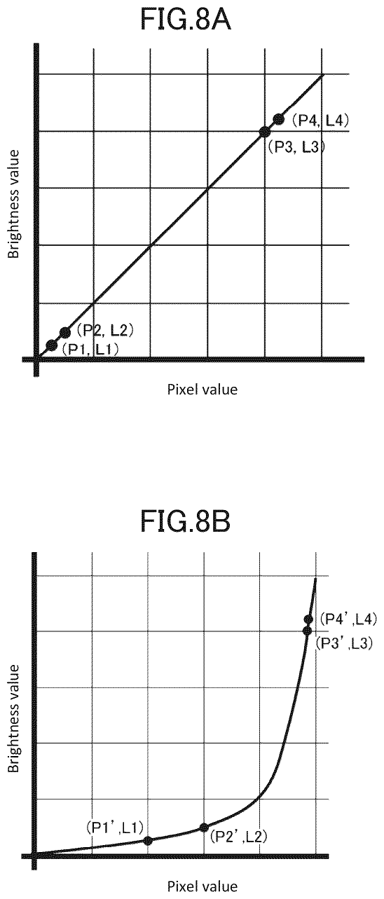

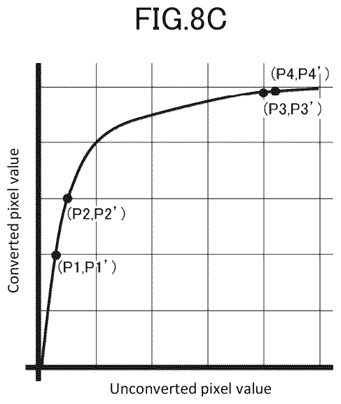

FIG. 7 is a drawing explaining the conversion process of the frame in the present embodiment. FIG. 8A is a graph illustrating an example of the relationship between the pixel value and the brightness value in the one or more of input frames. FIG. 8B is a graph illustrating an example of the relationship between the pixel value and the brightness value in the one or more of input frames after the conversion. FIG. 8C is a graph illustrating an example of the conversion function.

In the present embodiment, the process target frame 20 and the one or more of input frames 22 to be generated based on the process target frame 20 are images in which the relationship between the pixel value and the brightness value is linear. Each pixel included in the image is displayed on the display unit 18 with the brightness according to the brightness value corresponding to the pixel value.

Here, a human has the following visual sense properties: he/she has the high sensitivity with respect to a difference in brightness in a low-brightness area, and has the low sensitivity with respect to the difference in brightness in a high-brightness area. Therefore, even if the image quality of the frame is improved in the high-brightness area, it is difficult to recognise that the image quality is improved. On the other hand, if the image quality of the frame is improved in the low-brightness area, it can be keenly recognised that the image quality is improved.

Thus, in the present embodiment, there is adopted is a configuration in which the one or more of input frames 22 are inputted to the machine learning model 200 with more gradations allocated to the low-brightness area than to the high-brightness area in accordance with the visual sense properties of a human.

As shown in FIG. 7, before the one or more of input frames 22 are inputted to the machine learning model 200, the non-linear conversion is performed on the one or more of input frames 22 by the non-linear conversion unit 501. The non-linear conversion may take place, for example, based on the conversion function shown in FIG. 8C. Hereinafter, the one or more of input frames 22 on which the non-linear conversion is performed is called “the converted input frame 22C” below. As shown in FIG. 8B, in the converted input frame 22C, the pixel value and the brightness value thereof are in the non-linear relationship. FIG. 7 shows an example of the non-linear conversion taking place based on a conversion function (PQ EOTF-1) by the so-called PQ (Perceptual Quantizer) method. The PQ method is one type of standard for realizing an image expression in accordance with the visual sense properties of a human.

FIG. 8A shows an example of the brightness values L1 to L4 respectively corresponding to pixel values P1 to P4 in the one or more of input frames 22. FIG. 8B shows an example of the brightness values L1 to L4 respectively corresponding to pixel values P1′ to P4′ in the converted input frame 22C. As shown in FIGS. 8A and 8B, in the low-brightness area (brightness values L1, L2), the width of the corresponding pixel values is larger to the converted input frame 22C than to the one or more of input frames 22. On the other hand, in the high-brightness area (brightness values L3, L4), the width of the corresponding pixel values is approximately identical in the one or more of input frames 22 and the converted input frame 22C. Namely, the converted input frame 22C is an image to which the pixel values (gradations) are allocated more to the low-brightness area than to the high-brightness area.

The converted input frame 22C is inputted to the machine learning model 200. Then, the machine learning model 200 outputs the estimation frame 24. In the estimation frame 24, the pixel value and the brightness value thereof are in the non-linear relationship, like the converted input frame 22C.

With the non-linear conversion performed on the estimation frame 24 by the linear conversion unit 502, the frame in which the relationship between the pixel value and the brightness value is linear is generated. This non-linear conversion may be a reverse conversion of the non-linear conversion by the non-linear conversion unit 501. FIG. 7 shows an example of the non-linear conversion performed based on the conversion function (PQ EOTF) by the PQ method. Hereinafter, the estimation frame 24 on which the non-linear conversion is performed may also be called “the converted estimation frame 24C.” The converted estimation frame 24C is outputted to the display unit 18, after various visual effects by a game engine take place. The estimation frame 24 is converted to the frame in which the relationship between the pixel value and the brightness value is linear, because the frame in which the pixel value and the brightness value are in the linear relationship is more suitable in all the processes until the display by the display unit 18 takes place. However, as explained in the 2nd variation described below, the non-linear conversion with respect to the estimation frame 24 is not essential.

In the present embodiment, the training data which is used for the learning by the machine learning model 200 may be data which includes the learning input frame in which the pixel value and the brightness value are in the non-linear relationship, and the learning estimation frame in which the pixel value and the brightness value are in the non-linear relationship.

### 5. Process Executed by the Image Processing System

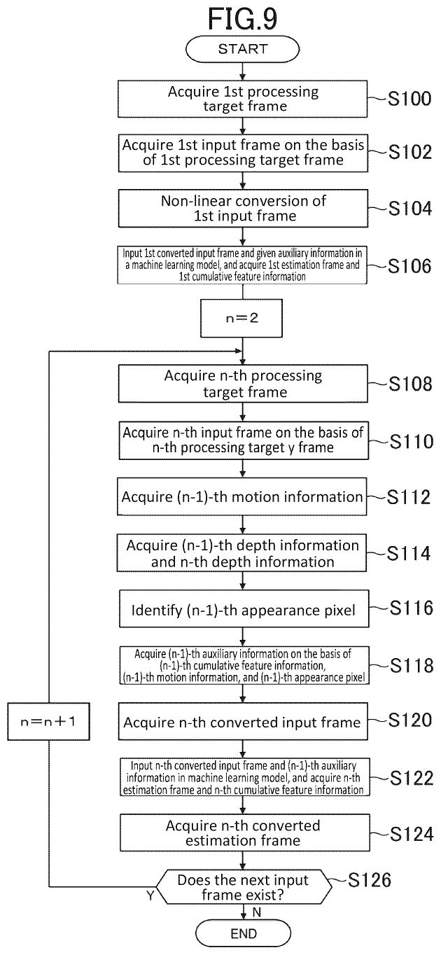

FIG. 9 is a flowchart illustrating an example of the flow of the process executed by the image processing system 1. The process shown in FIG. 9 is executed by the control unit 10 operating in accordance with the program stored in the storage unit 12.

### (1) Process in N=1

First, the control unit 10 acquires the 1st process target frame 20_1 (S100). The control unit 10 acquires the 1st input frame 22_1 based on the 1st processing target frame 20_1 (S102). Then, the control unit 10 acquires the 1st converted input frame 22C_1 in which the relationship between the pixel value and the brightness value is non-linear, the 1st converted input frame 22C_1 being generated by performing the non-linear conversion on the 1st input frame 22_1 (S104). Furthermore, the control unit 10 inputs the 1st converted input frame 22C_1 and the given auxiliary information to the machine learning model 200, and acquires the 1st estimation frame 24_1 and the 1st cumulative feature information 26_1 (S106).

### (2) Process In N≥2

The control unit 10 acquires the nth process target frame 20_n (S108). The control unit 10 acquires the nth input frame 22_n based on the nth process target frame 20_n (S110).

Next, the control unit 10 acquires the (n−1)th motion information (S112). Moreover, the control unit 10 acquires the (n−1)th depth information and the nth depth information (S114), and specifies the nth appearance pixel 422_n based on the (n−1)th depth information and the nth depth information (S116). The control unit 10 acquires the (n−1)th auxiliary information 28_n−1 based on the (n−1)th cumulative feature information 26_n−1, the (n−1)th motion information, and the nth appearance pixel 422_n (S118).

Moreover, the control unit 10 acquires the 1st converted input frame 22C_n−1 in which the relationship between the pixel value and the brightness value is non-linear, the 1st converted input frame 22C_n−1 being generated by performing the non-linear conversion on the (n−1)th input frame 22_n−1 (S120).

Then, the control unit 10 inputs the nth converted input frame 22C_n and the (n 1)th auxiliary information 28_n−1 to the machine learning model 200, and acquires the nth estimation frame 24_n and the nth cumulative feature information 26_n (S122).

Moreover, the control unit 10 acquires the nth converted estimation frame 24C_n in which the relationship between the pixel value and the brightness value is linear, the nth converted estimation frame 24C_n being generated by performing the non-linear conversion on the nth estimation frame 24_n (S124).

Then, the control unit 10 determines whether the next frame exists (S126), and if it is determined that the next frame does exist (S126; Y), the frame is incremented to n=n+1, and the processes of S108 to S124 are repeated. If the control unit 10 has determined that the next frame does not exist (S126; N), this process ends.

### 6. Summary

According to the image processing system 1 relating to the present embodiment as explained above, the (n−1)th cumulative feature information 26_n−1 indicating the features of the 1st to (n−1)th input frames 22 is used to estimate the nth estimation frame 24_n. Namely, in addition to the information of the nth input frame 22_n, since the information of the 1st to (n−1)th input frames 22 can be used for the estimation, the information that can be used for the estimation increases and the high-image quality estimation frame 24_n can be obtained.

Moreover, according to the image processing system 1 relating to the present embodiment, the gradation to be allocated to the high-brightness area in the one or more of input frames 22 is reduced and then the one or more of input frames 22 are inputted to the machine learning model 200, so that the process load in the machine learning model 200 can be reduced. The reduction of the process load is particularly effective when the image processing system 1 is applied to a game console with a limited processing performance. Moreover, the gradation to be allocated to the low-brightness area in the one or more of input frames 22 is increased and then the one or more of input frames 22 are inputted to the machine learning model 200, so that the estimation frame 24 suitable for the visual sense properties of a human can be obtained.

### 7. Frame Conversion Process in the Respective Variations of the Present Embodiment

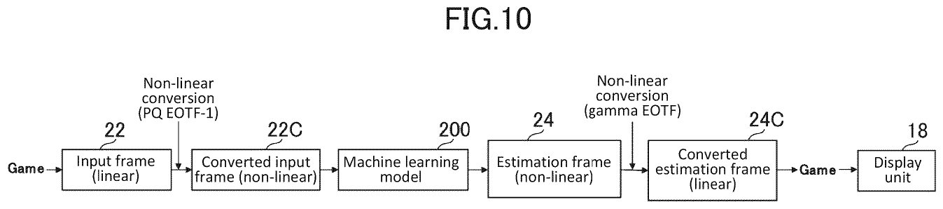

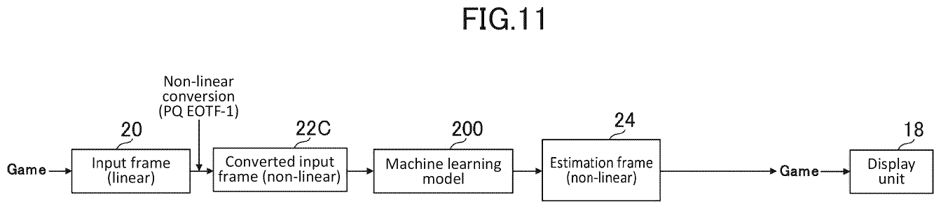

Next, referring to FIGS. 10 to 12, the conversion process of the frame in each of the variations of the present embodiment will be explained.

FIG. 10 is a drawing explaining the conversion process of the frame in the 1st variation of the present embodiment. In the aforementioned FIG. 7, the example of the non-linear conversion using the PQ method is explained, while the non-linear conversion method is not limited to this. FIG. 10 shows an example of generating the converted estimation frame 24C by performing the non-linear conversion on the estimation frame 24 by the so-called gamma method.

While the aforementioned PQ method provides higher image quality and precise colour reproduction, a complex algorithm is utilized for data processing and encoding, and the process load is large. Thus, as shown in FIG. 10, whilst the image quality improvement in the low-brightness area is realized by applying a conversion function to the non-linear conversion of the one or more of input frames 22 in the PQ method, the process load can be reduced by applying the gamma method to the non-linear conversion of the estimation frame 24.

The conversion method is not limited to the above-described method, as long as the relationship between the pixel value and the brightness value has only to be based on the linear and non-linear conversion, for example, the HLG (Hybrid Log-Gamma) method, etc. may also be utilized.

FIG. 11 is a drawing explaining the conversion process of the frame in the 2nd variation of the present embodiment. The aforementioned FIGS. 7 and 9 show an example of performing the non-linear conversion on the estimation frame 24, while this non-linear conversion also need not be performed. This is because, depending on the process method by a game engine and the display specifications, displaying based on the frame in which the relationship between the pixel value and the brightness value is non-linear can take place. Therefore, as shown in FIG. 11, the estimation frame 24 in which the relationship between the pixel value and the brightness value is non-linear may also be outputted to the display unit 18.

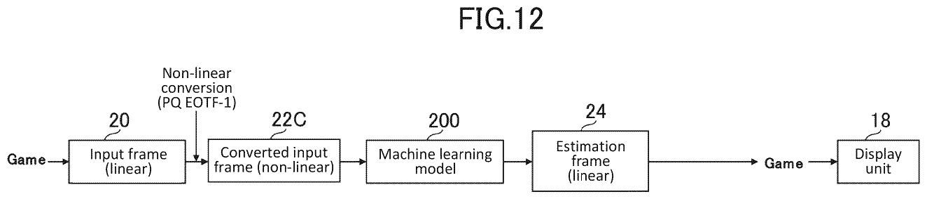

FIG. 12 is a drawing explaining the conversion process of the frame in the 3rd variation of the present embodiment. The aforementioned FIGS. 7, 10 and 11 show examples of the machine learning model 200 outputting the estimation frame 24 in which the relationship between the pixel value and the brightness value is non-linear, based on the converted input frame 22C in which the relationship between the pixel value and the brightness value is non-linear, the process is not limited to this. Namely, as shown in FIG. 12, the machine learning model 200 may also output the estimation frame 24 in which the relationship between the pixel value and the brightness value is linear, based on the input of the converted input frame 22C in which the relationship between the pixel value and the brightness value is non-linear. In this case, the machine learning model 200 may be learned by the plurality of training data which includes the learning input frame in which the relationship between the pixel value and the brightness value is non-linear, and the learning estimation frame in which the relationship between the pixel value and the brightness value is linear. In the 3rd variation, the non-linear conversion does not need to be performed on the estimation frame 24 which was outputted by the machine learning model 200, so that the process load by the control unit 10 can be reduced.

The example of using the standardised existing method such as the PQ method and the gamma method is explained in the aforementioned the present embodiment and each of the variations, while the present embodiment and each of the variations are not limited to this. For example, the conversion function by the PQ method may also be substituted with the approximation formula. Thereby, the process load required for the non-linear conversion by the control unit 10 can be reduced.

Moreover, the image generated by the non-linear conversion of the non-linear conversion unit 501 may be based on, for example, a YUV space which expresses colours by combining a brightness signal (Y), a difference (U) between the brightness signal and a blue colour component and a difference (V) between the brightness signal and a red colour component. However, on the color spaces are not limited to such existing colour spaces, and a unique colour space may also be used. For example, a loss function expressing the difference between the estimation frame 24 outputted by the machine learning model 200 and the learning estimation frame may be acquired, and a colour space suitable for the performance of the machine learning model 200 in accordance with the loss function may be searched. Then, the frame converted in the searched colour space may be inputted to the machine learning model 200.

Moreover, the invention according to the present disclosure is not limited to the aforementioned embodiment and each of the variations. For example, the case where the input pixel number is greater than the initial pixel number, and where the input pixel number and the estimated pixel number are identical is exemplified in the present embodiment. Meanwhile, the input pixel number and initial pixel number may also be identical, and the estimated pixel number may also be greater than the input pixel number. Namely, the one or more of input frames 22 need not necessarily be an enlarged process target frame 20.

Moreover, in the present embodiment and each of the variations, the moving image in which the one or more of input frames 22 is sequentially inputted is explained as the example. Meanwhile, the present embodiment and each of the variations are not limited to this, and the still image may also be inputted to the image processing system 1. Namely, N=1 may also be used.

### 8. Addenda

(1)

An image processing system including at least one processor, where
the at least one processor:
acquires one or more of input frames in which a pixel value and a brightness value are in a linear relationship,
generates a converted input frame in which a pixel value and a brightness value are in a non-linear relationship in accordance with the visual sense properties of a human by performing non-linear conversion on the input frame, and
inputs the converted input frame to a machine learning model to acquire an estimation frame.
   (2)

An image processing system according to (1), where
the at least one processor
acquires each of the 1st to Nth input frames (N is a natural number equal to or greater than 2),
generates each of the 1st to Nth converted input frames by performing non-linear conversion on each of the 1st to Nth input frames, and
inputs the 1st to Nth converted input frames to the machine learning model to acquire each of the 1st to Nth estimation frames.
   (3)

An image processing system according to (2), where
the machine learning model includes:
a cumulative feature information output layer has the nth (2≤n≤N) converted input frame and the (n−1)th auxiliary information based on (n−1)th cumulative feature information which is image information indicating the features of the 1st to (n−1)th converted input frames inputted thereto, and outputs the nth cumulative feature information indicating the features of the 1st to nth converted input frames; and
an estimation frame output layer has the nth cumulative feature information inputted thereto, and outputs the nth estimation frame.
   (4)

An image processing system according to any of (1) to (3), where
the at least one processor
generates a converted estimation frame in which a pixel value and a brightness value are in a linear relationship by performing non-linear conversion on the estimation frame.
   (5)

An image processing system according to (4), where
the machine learning model has learnt by a plurality of training data which includes
a learning input frame in which a pixel value and a brightness value are in a non-linear relationship, and
a learning estimation frame in which a pixel value and a brightness value are in a non-linear relationship.
   (6)

An image processing system according to any of (1) to (5), where
the machine learning model has learnt by a plurality of training data which includes
a learning input frame in which a pixel value and a brightness value are in a non-linear relationship, and
a learning estimation frame in which a pixel value and a brightness value are in a linear relationship.
   (7)

An image processing system according to any of (1) to (5), where
each of the input frames is an image obtainable by executing rendering of three-dimensional data indicating one or more objects as seen from a prescribed viewpoint.
   (8)

An image processing method, where a processor
acquires one or more of input frames in which a pixel value and a brightness value are in a linear relationship,
generates a converted input frame in which a pixel value and a brightness value are in a non-linear relationship in accordance with the visual sense properties of a human by performing non-linear conversion on the input frame, and
inputs the converted input frame to a machine learning model to acquire an estimation frame.
   (9)

A program for functioning on a computer, where
the program has:
one or more of input frames acquisition means for acquiring one or more of input frames in which a pixel value and a brightness value are in a linear relationship,
a conversion means for generating a converted input frame in which a pixel value and a brightness value are in a non-linear relationship in accordance with the visual sense properties of a human by performing non-linear conversion on the input frame; and
an estimation frame acquisition means for inputting the converted input frame to a machine learning model to acquire an estimation frame.

What is claimed is:

1. An image processing system comprising:
one or more storage media storing instructions; and
one or more processors configured to execute the instructions to cause the image processing system to:
acquire one or more input frames in which a first pixel value and a first brightness value are in a linear relationship;
generate a converted input frame in which a second pixel value and a second brightness value are visually in a non-linear relationship by performing a non-linear conversion on the input frames; and
input the converted input frame to a machine learning model to cause an estimation frame to be acquired.

2. The image processing system of claim 1, wherein the instructions further cause the image processing system to:
acquire the 1st to Nth input frames (N is a natural number equal to or greater than 2) of the input frames;
generate each of the 1st to Nth converted input frames by performing the non-linear conversion on each of the 1st to Nth input frames; and
input the 1st to Nth converted input frames to the machine learning model to cause each of the 1st to Nth estimation frame to be acquired.

3. The image processing system of claim 2, wherein the machine learning model includes:
a cumulative feature information output layer includes the nth (2≤n≤N) converted input frame and the (n−1)th auxiliary information based on (n−1)th cumulative feature information, wherein the (n−1)th cumulative feature information indicates the features of the 1st to (n−1)th converted input frames inputted to the cumulative feature information output layer, and wherein the cumulative feature information output layer outputs the nth cumulative feature information indicating the features of the 1st to nth converted input frames; and
an estimation frame output layer that includes the nth cumulative feature information inputted thereto and outputs the nth estimation frame.

4. The image processing system of claim 1, wherein the instructions further cause the image processing system to generate a converted estimation frame in which a third pixel value and a third brightness value are in a linear relationship by performing the non-linear conversion on the estimation frame.

5. The image processing system of claim 4, wherein the machine learning model was trained using a plurality of training data including:
a learning input frame in which a first training pixel value and a first training brightness value are in a non-linear relationship; and
a learning estimation frame in which a second training pixel value and a second training brightness value are in a non-linear relationship.

6. The image processing system of claim 1, wherein the machine learning model was trained using a plurality of training data including:
a learning input frame in which a first training pixel value and a first training brightness value are in a non-linear relationship; and
a learning estimation frame in which a second training pixel value and a second training brightness value are in a linear relationship.

7. The image processing system of claim 1, wherein each of the input frames includes an image obtained by executing a rendering of three-dimensional data indicating one or more objects as seen from a prescribed viewpoint.

8. An image processing method comprising:
acquiring one or more input frames in which a first pixel value and a first brightness value are in a linear relationship;
generating a converted input frame in which a second pixel value and a second brightness value are visually in a non-linear relationship by performing a non-linear conversion on the input frames; and
inputting the converted input frame to a machine learning model to cause an estimation frame to be acquired.

9. The image processing method of claim 8, further comprising:
acquiring the 1st to Nth input frames (N is a natural number equal to or greater than 2) of the input frames;
generating each of the 1st to Nth converted input frames by performing the non-linear conversion on each of the 1st to Nth input frames; and
inputting the 1st to Nth converted input frames to the machine learning model to cause each of the 1st to Nth estimation frame to be acquired.

10. The image processing method of claim 9, wherein the machine learning model includes:
a cumulative feature information output layer includes the nth (2≤n ≤N) converted input frame and the (n−1)th auxiliary information based on (n−1)th cumulative feature information, wherein the (n−1)th cumulative feature information indicates the features of the 1st to (n−1)th converted input frames inputted to the cumulative feature information output layer, and wherein the cumulative feature information output layer outputs the nth cumulative feature information indicating the features of the 1st to nth converted input frames; and
an estimation frame output layer that includes the nth cumulative feature information inputted thereto and outputs the nth estimation frame.

11. The image processing method of claim 8, further comprising generating a converted estimation frame in which a third pixel value and a third brightness value are in a linear relationship by performing the non-linear conversion on the estimation frame.

12. The image processing method of claim 11, wherein the machine learning model was trained using a plurality of training data including:
a learning input frame in which a first training pixel value and a first training brightness value are in a non-linear relationship; and
a learning estimation frame in which a second training pixel value and a second training brightness value are in a non-linear relationship.

13. The image processing method of claim 8, wherein the machine learning model was trained using a plurality of training data including:
a learning input frame in which a first training pixel value and a first training brightness value are in a non-linear relationship; and
a learning estimation frame in which a second training pixel value and a second training brightness value are in a linear relationship.

14. The image processing method of claim 8, wherein each of the input frames includes an image obtained by executing a rendering of three-dimensional data indicating one or more objects as seen from a prescribed viewpoint.

15. One or more non-transitory computer-readable storage media storing instructions that, upon execution by one or more processors of an image processing system, cause the image processing system to perform operations comprising:
acquiring one or more input frames in which a first pixel value and a first brightness value are in a linear relationship;
generating a converted input frame in which a second pixel value and a second brightness value are visually in a non-linear relationship by performing a non-linear conversion on the input frames; and
inputting the converted input frame to a machine learning model to cause an estimation frame to be acquired.

16. The computer-readable storage media of claim 15, wherein the image processing system is caused to perform operations further comprising:
acquiring the 1st to Nth input frames (N is a natural number equal to or greater than 2) of the input frames;
generating each of the 1st to Nth converted input frames by performing the non-linear conversion on each of the 1st to Nth input frames; and
inputting the 1st to Nth converted input frames to the machine learning model to cause each of the 1st to Nth estimation frame to be acquired.

17. The computer-readable storage media of claim 16, wherein the machine learning model includes:
a cumulative feature information output layer includes the nth (2≤n≤N) converted input frame and the (n−1)th auxiliary information based on (n−1)th cumulative feature information, wherein the (n−1)th cumulative feature information indicates the features of the 1st to (n−1)th converted input frames inputted to the cumulative feature information output layer, and wherein the cumulative feature information output layer outputs the nth cumulative feature information indicating the features of the 1st to nth converted input frames; and
an estimation frame output layer that includes the nth cumulative feature information inputted thereto and outputs the nth estimation frame.

18. The computer-readable storage media of claim 15, wherein the image processing system is caused to perform operations further comprising generating a converted estimation frame in which a third pixel value and a third brightness value are in a linear relationship by performing the non-linear conversion on the estimation frame.

19. The computer-readable storage media of claim 15, wherein the machine learning model was trained using a plurality of training data including:
a learning input frame in which a first training pixel value and a first training brightness value are in a non-linear relationship; and
a learning estimation frame in which a second training pixel value and a second training brightness value are in a linear relationship.

20. The computer-readable storage media of claim 15, wherein each of the input frames includes an image obtained by executing a rendering of three-dimensional data indicating one or more objects as seen from a prescribed viewpoint.
